(19) United States
(12) Patent Application Publication
(10) Pub. No.: US 2025/0282332 A1
(43) Pub. Date: Sep. 11, 2025

(54) ELECTRONIC BRAKE APPARATUS

(71) Applicant: HL MANDO CORPORATION, Gyeonggi-do (KR)

(72) Inventors: Kwangseok HONG, Gyeonggi-do (KR); Dongyo RYU, Gyeonggi-do (KR)

(21) Appl. No.: 18/862,499

(22) PCT Filed: Mar. 8, 2023
(86) PCT No.: PCT/KR2023/003203

§ 371 Date: Nov. 1, 2024

(30) Foreign Application Priority Data
May 4, 2022 (KR) 10-2022-0055396

(51) Int. Cl. B60T 7/04; B60T 13/74

(52) U.S. Cl. CPC B60T 7/042; B60T 13/745

(57) ABSTRACT

An electronic brake apparatus is disclosed. The electronic brake apparatus includes: an input unit configured to move in a first direction according to a movement of a brake pedal; an output unit configured to be pressed according to a movement of the input unit and press a piston of a master cylinder connected to the output unit in the first direction; an electric booster including a motor, a rack configured to press the output unit, and a motion conversion unit configured to convert a rotational motion of the motor into a linear motion of the rack and move the rack forward or backward in the first direction; and an electronic control unit configured to control an operation of the motor according to a movement of the input unit, wherein the electronic control unit is positioned to one side in second direction of the electric booster.

### TECHNICAL FIELD

The disclosure relates to an electronic brake apparatus, and more particularly, to an electronic brake apparatus capable of simplifying an electronic control structure of an electric booster for adjusting pressure of a master cylinder.

### BACKGROUND ART

Recently, hybrid vehicles, fuel cell vehicles, and electric vehicles are being actively developed to improve fuel efficiency and reduce exhaust gas emissions. These vehicles are necessarily equipped with a brake system, i.e., a brake apparatus. Herein, the brake apparatus of the brake system refers to an apparatus that functions to reduce the speed of the running vehicle or stop the vehicle.

Because the brake system should supply the suction pressure of the vehicle engine to a vacuum booster in order to create a vacuum, the brake system needs to be equipped with a separate engine or a vacuum generator.

However, Electronic Vehicles (EV) that do not have engines which are common vacuum generating sources or hybrid vehicles in which the engines do not always operate have a problem in that it is difficult to generate back pressure that satisfies the braking force of the vehicles if separate vacuum generators are not installed.

Therefore, recently, a brake system including an electric booster that uses a motor instead of a vacuum booster is being developed.

In an electronic brake apparatus including an electric booster, the pedal effort sensor detects, when a driver steps on the brake pedal, the driver's pedal effort and the Electronic Control Unit (ECU) drives the motor of the electric booster based on a detection value of the pedal effort sensor to transfer a boosted force to the master cylinder. The master cylinder transmits a hydraulic force toward the wheel brakes based on the boosted force transferred from the electric booster.

For this operation, the electronic control unit of the electronic brake apparatus needs to be connected to the pedal effort sensor for detecting a pedal effort or a pedal travel sensor for detecting a movement of the pedal by a pedal effort, and a motor sensor for detecting a rotation of the motor. To this end, it is necessary to position the sensors at the respective locations of the brake apparatus and electrically connect the sensors to the control circuit of the electronic control unit. In the case in which the sensors are far away from the control circuit of the electronic control unit, wirings for electrically connecting them are provided and connectors for coupling the wirings with each other are separately provided, which makes the structure complex and results in low performance in assembly.

### DISCLOSURE

### Technical Problem

The disclosure provides an electronic brake system capable of simplifying an electronic control structure of an electric booster that adjusts pressure of a master cylinder.

### Technical Solution

An electronic brake apparatus according to an aspect of the disclosure may include: an input unit configured to move in a first direction according to a movement of a brake pedal; an output unit configured to be pressed according to a movement of the input unit and press a piston of a master cylinder connected to the output unit in the first direction; an electric booster including a motor, a rack configured to press the output unit, and a motion conversion unit configured to convert a rotational motion of the motor into a linear motion of the rack and move the rack forward or backward in the first direction; and an electronic control unit configured to control an operation of the motor according to a movement of the input unit, wherein the electronic control unit is positioned to one side in second direction of the electric booster.

The electronic control unit may include: a motor position sensor configured to detect a rotation of the motor; a pedal travel sensor configured to detect a movement of the input unit; and a Printed Circuit Board (PCB) configuring an electronic circuit for controlling the motor.

A rotation shaft of the motor may be aligned in a second direction, the PCB may be positioned to one side in second direction of the motor, and the motor position sensor may be positioned to one side in second direction of the motor on the PCB to detect a rotation of the motor.

The electronic brake apparatus may further include: a sensor rod connected to the input unit, extending in the second direction, and moving together with the input unit; and a PTS magnet provided at one end of the sensor rod, wherein the pedal travel sensor may be provided to one side in second direction of the PTS magnet on the PCB to detect a movement of the PTS magnet.

The rack may include a hollow portion formed in the first direction, the input unit may be positioned inside the hollow portion of the rack and move in the first direction, and the sensor rod may be connected to the input unit between the output unit and the rack.

The PCB may include a first PCB and a second PCB, the motor position sensor may be positioned on the first PCB, the pedal travel sensor may be positioned on the second PCB, and the first PCB may be electrically connected to the second PCB.

The output unit may include: an output rod configured to press the piston of the master cylinder; a reaction disk configured to be pressed by the input unit and press the output rod; and a boost body configured to be pressed by the rack or the input unit and press the reaction disk.

When the rack moves forward in the first direction to press the boost body, the rack may come into contact with the input unit and move the input unit forward in the first direction.

When the brake pedal is pressed to move in the first direction, the input unit may move independently from the rack.

While the brake pedal is not pressed, the input unit may be spaced a preset gap from the reaction disk.

### Advantageous Effects

An electronic brake apparatus according to an embodiment may reduce a package size and simplify a connection structure for sensors by positioning an integrated structure of a motor position sensor and a pedal travel sensor to one side of an electric booster on a Printed Circuit Board (PCB) that configures an electronic circuit for control.

### DESCRIPTION OF DRAWINGS

FIG. 1 is a perspective view schematically showing an electronic brake apparatus according to an embodiment of the disclosure.

FIG. 2 is a perspective view schematically showing an internal configuration of an electronic brake apparatus according to an embodiment of the disclosure.

FIG. 3 is a front view schematically showing an internal configuration of an electronic brake apparatus according to an embodiment of the disclosure.

FIG. 4 is a side view schematically showing an internal configuration of an electronic brake apparatus according to an embodiment of the disclosure.

FIG. 5 is a cross-sectional view showing the internal configuration of the electronic brake apparatus shown in FIG. 3, taken along line A-A′.

FIGS. 6 to 9 are operation diagrams schematically showing operations of an electronic brake apparatus according to an embodiment of the disclosure.

FIG. 10 is a partially cross-sectional view schematically showing a coupled state of an input unit, an output unit, and a rack of an electronic brake apparatus according to an embodiment of the disclosure.

### MODES OF THE INVENTION

Throughout this specification, like reference numerals will refer to like components. The present specification does not describe all elements of embodiments, and descriptions about content being general in the technical art to which the disclosure belongs or overlapping content between the embodiments will be omitted. As used herein, the terms “portion”, “part, “module, “member” or “block” may be implemented as software or hardware, and according to embodiments, a plurality of “portions”, “parts, “modules, “members” or “blocks” may be implemented as a single component, or a single “portion”, “part, “module, “member” or “block” may include a plurality of components.

Through this specification, it will be understood that when a certain part is referred to as being “connected” to another part, it can be directly or indirectly connected to the other part. When a part is indirectly connected to another part, it may be connected to the other part through a wireless communication network.

Also, it will be understood that when a certain part “includes” a certain component, the part does not exclude another component but can further include another component, unless the context clearly dictates otherwise.

The terms “first”, “second”, etc., are used only to distinguish one component from another, and components should not be limited by these terms.

The singular forms “a,” “an,” and “the” include plural referents unless the context clearly dictates otherwise.

Hereinafter, an operation principle and embodiments of the disclosure will be described with reference to the accompanying drawings.

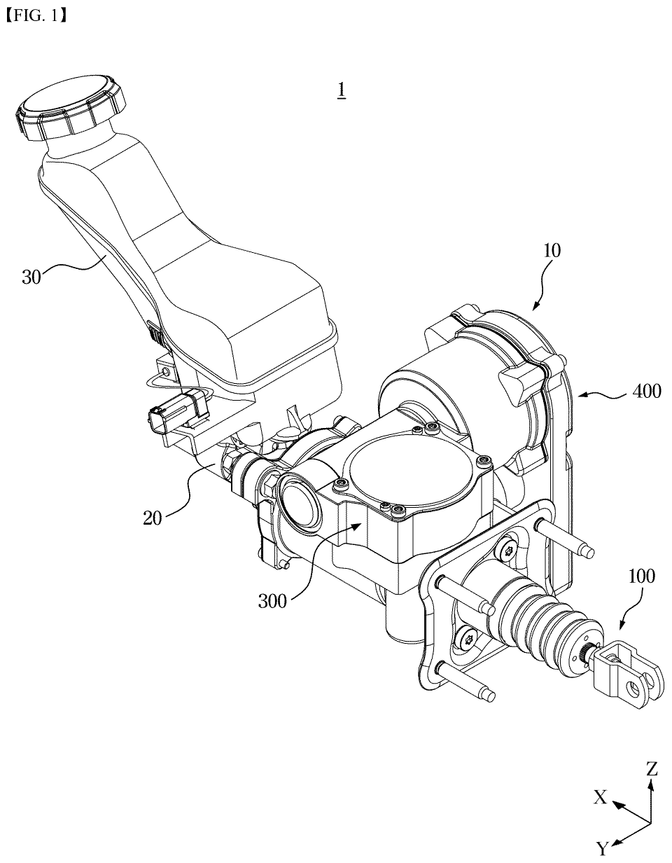

FIG. 1 is a perspective view schematically showing an electronic brake apparatus according to an embodiment of the disclosure.

Referring to FIG. 1, an electronic brake apparatus 1 according to an embodiment of the disclosure may include: a master cylinder 20 in which a piston 21 presses brake oil to generate hydraulic pressure; a reservoir 30 that supplies brake fluid to the master cylinder 20; and a booster 10 that drives a motor in response to a driver's brake pedal operation to press the piston 21 of the master cylinder 20. The booster 10 may be used to transfer a boosted force to the master cylinder 20 in response to a driver's pedal stroke by using a motor, and may include: an input unit 100 that moves in a first direction (X direction) according to a movement of a brake pedal; an output unit 200 that is pressed according to a movement of the input unit 100 to press the piston 21 of the master cylinder 20 connected to the output unit 200 in the first direction; an electric booster 300 including a motor 310, a rack 320 for pressing the output unit 200, and a motion conversion unit 330 for converting a rotational motion of the motor 310 into a linear motion of the rack 320 to move the rack 320 forward or backward in the first direction; and an electronic control unit 400 that controls an operation of the motor 310 according to a movement of the input unit 100.

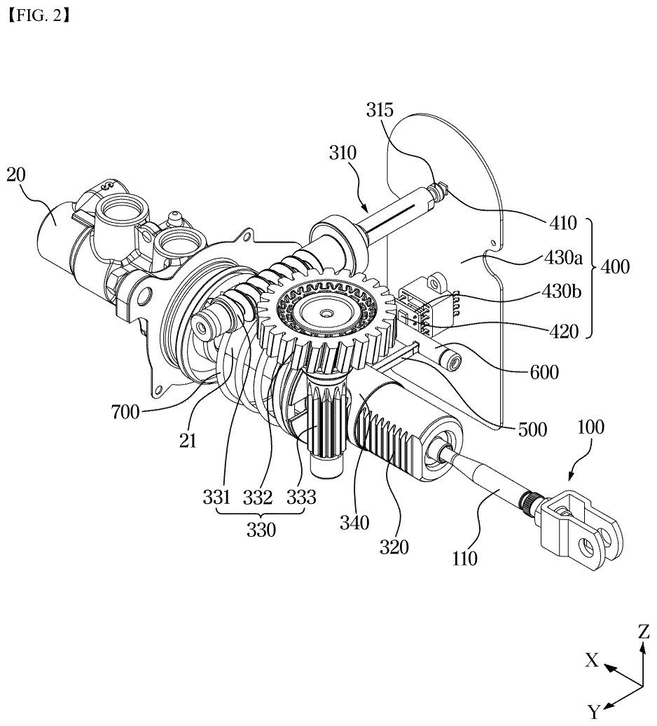

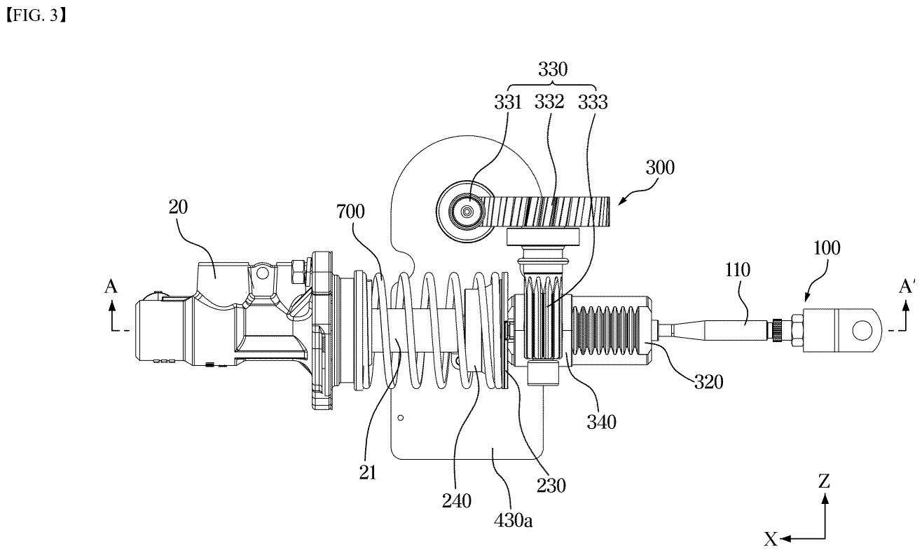

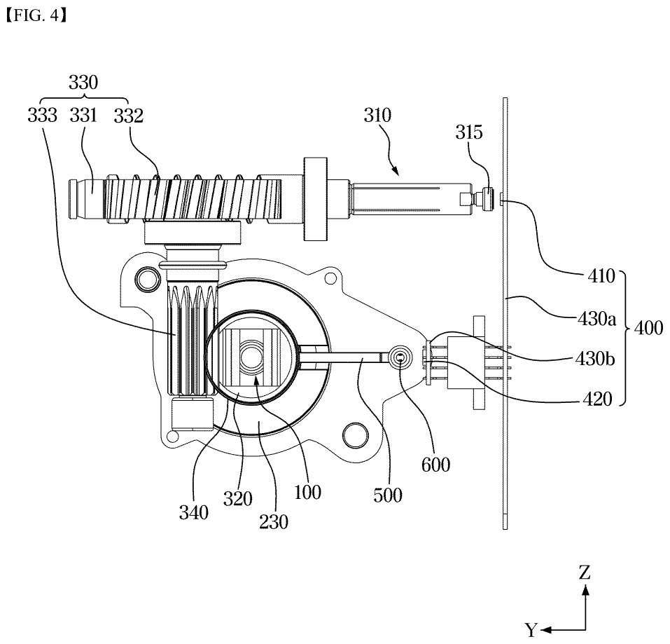

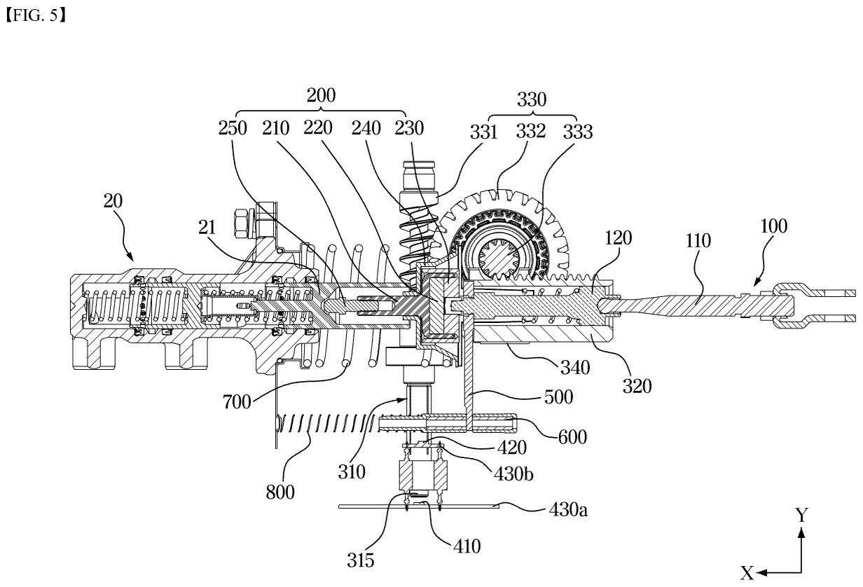

FIG. 2 is a perspective view schematically showing an internal configuration of an electronic brake apparatus according to an embodiment of the disclosure, FIG. 3 is a front view schematically showing an internal configuration of an electronic brake apparatus according to an embodiment of the disclosure, FIG. 4 is a side view schematically showing an internal configuration of an electronic brake apparatus according to an embodiment of the disclosure, and FIG. 5 is a cross-sectional view showing the internal configuration of the electronic brake apparatus shown in FIG. 3, taken along line A-A′.

In FIGS. 2 to 5, structures and positions of the input unit 100, the output unit 200, the electric booster 300, and the electronic control unit 400 of the electronic brake apparatus shown in FIG. 1 are shown.

The electronic brake apparatus 1 may include: the input unit 100 that moves in the first direction (X direction) according to a movement of the brake pedal; the output unit 200 that is pressed according to a movement of the input unit 100 to press the piston 21 of the master cylinder 20 connected to the output unit 200 in the first direction; the electric booster 300 including the motor 310, the rack 320 for pressing the output unit 200, and the motion conversion unit 330 for converting a rotational force of the motor 310 into a linear motion of the rack 320 to move the rack 320 forward or backward in the first direction; and the electronic control unit 400 that controls an operation of the motor 310 according to a movement of the input unit 100.

In this case, the electronic control unit 400 may include: a motor position sensor 410 that detects a rotation of the motor 310; a pedal travel sensor 420 that detects a movement of the input unit 100; and a Printed Circuit Board PCB 430 that configures an electronic circuit for controlling the motor 310.

The master cylinder 20 may transfer a hydraulic force to a wheel brake (not shown) based on a boosted force transferred from the booster 10. At this time, brake oil stored in the reservoir 30 may be used. The hydraulic force transferred from the master cylinder 20 may mean pressure of the brake oil generated from the master cylinder 20 toward the wheel brake in order to generate a desired friction braking force at each wheel brake.

The master cylinder 20 may include the first piston 21, a second piston, a first spring, and a second spring to have two hydraulic circuits.

The master cylinder 20 may have the two hydraulic circuits to secure safety when a failure occurs. For example, a first circuit of the two hydraulic circuits may be connected to a right front wheel and a left rear wheel of a vehicle, and the other circuit may be connected to a left front wheel and a right rear wheel. Alternatively, unlike this, it is general that the first circuit of the two hydraulic circuits is connected to the two front wheels and the other circuit is connected to the two rear wheels. As such, configuring two circuits independently may be aimed to brake the vehicle even when any circuit fails.

The first piston 21 of the master cylinder 20 may compress the first spring, and the second piston may compress the second spring sequentially. Accordingly, the brake oil inside the master cylinder 20 may be compressed to generate brake hydraulic pressure.

The input unit 100 may include: a push rod 110 connected to the brake pedal and moving in the first direction according to a movement of the brake pedal; and a control plunger 120 moving according to a movement of the push rod 110 to press a reaction disk 220 which will be described below. The push rod 110 may include a clevis to be connected to the brake pedal, as shown.

The output unit 200 may include: an output rod 210 that presses the piston 21 of the master cylinder 20; the reaction disk 220 that is pressed by the input unit 100 to press the output rod 210; a boost body 230 that is pressed by the rack 320 or the input unit 100 to press the reaction disk 220; an output rod retainer 240 that supports the output rod 210; and an adjuster 250 that adjusts a gap between the output rod 210 and the piston 21 of the master cylinder 20. The output unit 200 may move forward according to a forward movement of the rack 320 to move the piston 21 of the master cylinder 20 forward, thereby increasing pressure of the master cylinder 20, and the output unit 200 may move backward according to a backward movement of the rack 320 to move the piston 21 of the master cylinder 20 backward, thereby decreasing pressure of the master cylinder 20. Or, the output unit 200 may be in contact with the input unit 100 and move forward according to a forward movement of the input unit 100 by a pedal stroke to move the piston 21 of the master cylinder 20 forward, thereby increasing pressure of the master cylinder 20, and the output unit 200 may move backward according to a backward movement of the input unit 100 to move the piston 21 of the master cylinder 20 backward, thereby decreasing pressure of the master cylinder 20.

Meanwhile, a return spring 700 may be connected to the output rod retainer 240. The return spring 700 may be provided between the output rod retainer 240 coupled to the output rod 210 and the master cylinder 20 to move the output rod 210 backward while the output rod 210 is not pressed by the input unit 100 or the rack 320, thereby decreasing pressure of the master cylinder 20.

The motor 310 may be a motor capable of selecting a forward rotation which is a rotation in one direction and a backward rotation which is a rotation in the opposite direction. In the drawings, for convenience of description, a stator, a rotor, and a driving circuit for driving the motor 310 are omitted, and only a rotating shaft of the motor 310 is shown. The rack 320 may be movable linearly in such a way as to move forward or backward in the first direction. The motion conversion unit 330 may convert a rotation motion of the motor 310 into a linear motion of the rack 320. The motion conversion unit 330 may be a pinion gear of which one side is connected to the rotating shaft of the motor 310 and another side is connected to the rack 320.

The rack 320 may have a hollow portion formed in the first direction. In this case, the input unit 100 may be positioned inside the hollow portion of the rack 320 and move in the first direction. As such, because the input unit 100 that presses the output rod 210 is positioned inside the hollow portion provided in the rack 320, a size of a pressing structure may be reduced.

The motion conversion unit 330 may convert a rotation motion of the motor 310 into a linear motion of the rack 320, while amplifying power generated from the motor 310 through a reduction device and transferring the power to the rack 320. For example, the motion conversion unit 330 may include a worm shaft 331 connected to the rotating shaft to rotate according to driving of the motor 310 and having a worm gear formed on the outer circumferential surface, a worm wheel 332 having gear teeth engaged with the worm gear of the worm shaft 331, and a pinion gear 333 which rotates by a rotation of the worm wheel 332 and is engaged with the rack 320. That is, the worm wheel 332 may rotate together with the pinion gear 333 by a rotation force transferred from the worm shaft 331 by a rotation of the motor 310, and the rack 320 engaged with the pinion gear 333 may move forward or backward in the first direction to press or release the output road 210.

Meanwhile, the electric booster 300 may further include a bush 340 that supports the rack 320 and prevents departure of the pinion gear 33.

The electronic control unit (ECU) 400 may detect, when a driver steps on the brake pedal, a pedal stroke through the pedal travel sensor 420, rotate the motor 310 in one direction to generate target brake pressure corresponding to the detected pedal stroke, and thus move the rack 320 forward through the motion conversion unit 330. Accordingly, the rack 320 may move the output unit 200 forward and the output unit 200 moved forward may press the piston 21 being in close contact with the output unit 200. Therefore, the brake oil inside the master cylinder 20 may be compressed and thus pressure of the master cylinder 20 may increase.

Also, the electronic control unit 400 may rotate, when the driver takes his/her foot off the brake pedal to release the brake pedal, the motor 310 in the opposite direction to move the rack 320 backward through the motion conversion unit 330. Accordingly, the output unit 200 may move backward according to the backward movement of the rack 320 and thus pressure of the master cylinder 20 may decrease.

Meanwhile, referring to FIGS. 2 to 5, the electronic brake apparatus 1 according to an embodiment of the disclosure may further include a sensor rod 500 connected to the input unit 100, extending in a second direction (Y direction), and moving together with the input unit 100; and a PTS magnet 600 provided at one end of the sensor rod 500. That is, the PTS magnet 600 positioned in the second direction from the input unit 100 may be connected to the input unit 100 via the sensor rod 500, and move in the first direction together with the input unit 100 moving in the first direction.

The pedal travel sensor 420 may be provided to one side in second direction of the PTS magnet 600, on the PCB 430, and detect a movement of the PTS magnet 600 to detect a movement of the input unit 100.

Meanwhile, the motor position sensor 410 may detect a position of the motor 310, that is, at least one of an absolute angle and a relative angle according to a rotation of the motor 310, and provide the detected result to the electronic control unit 400. To this end, the motor position sensor 410 may include at least one of a relative angle sensor that detects a relative rotation angle of the motor 310 and an absolute angle sensor that detects an absolute rotation angle of the motor 310. To this end, a MPS magnet 315 may be provided in the rotating shaft or the rotor of the motor 310 to rotate according to a rotation of the motor 310, and the motor position sensor 410 may detect a rotation of the motor 310 by detecting a rotation of the MPS magnet 315.

In this case, as shown in FIGS. 2 to 5, the rotating shaft of the motor 310 may be aligned in the second direction (Y direction) that is perpendicular to the first direction (X direction) as a movement direction of the rack 320, the PCB 430 may be positioned to one side in second direction of the motor 310, and the motor position sensor 410 may be provided to one side in second direction of the motor 310, on the PCB 430.

That is, as shown in FIGS. 2 to 5, because the motor position sensor 410 is positioned to one side in second direction of the motor 310, the pedal travel sensor 420 is also positioned around the PTS magnet 600 located in the second direction from the input unit 100, and the motor position sensor 410 and the pedal travel sensor 420 are located on the PCB configuring an electronic circuit, the entire electronic control unit 400 may be positioned to one side in second direction of the electric booster 300.

As such, by positioning an integrated structure of the motor position sensor 410 and the pedal travel sensor 420 to one side of the electric booster 300 on the PCB 430 configuring the electronic circuit for control, a package size may be reduced and a connection structure for sensors may be simplified.

Meanwhile, the PCB 430 may include a first PCB 430a and a second PCB 430b, the motor position sensor 410 may be positioned on the first PCB 430a, the pedal travel sensor 420 may be positioned on the second PCB 430b, and the first PCB 430a may be electrically connected to the second PCB 430b.

As described above, although the PTS magnet 600 is located close to the PCB 430 positioned to one side in second direction of the electric booster 300 by the sensor rod 500 extending in the second direction from the input unit 100, sensitivity of the pedal travel sensor 420 may be lowered by a movement of the PTS magnet 600 due to deformation and vibration of the sensor rod 500 as a length of the sensor rod 500 increases. Accordingly, in an embodiment of the disclosure, the electronic control unit 400 may be configured by positioning the motor position sensor 410 and the pedal travel sensor 420 respectively on two PBCs 430a and 430b and electrically connecting the two PBCs 430a and 430b to each other. As such, by configuring the electronic control unit 400 through the two PCBs 430a and 430b, the length of the sensor rod 500 may be reduced and the electronic control unit 400 including the motor position sensor 410 and the pedal travel sensor 420 may be positioned to one side of the electric booster 300.

Meanwhile, a magnet spring 800 may be provided between the PTS magnet 600 and a case of the booster 10. The magnet spring 800 may be pressed when the PTS magnet 600 moves forward in the first direction to minimize a gap of the PTS magnet 600 and thus increase accuracy of the pedal travel sensor 420.

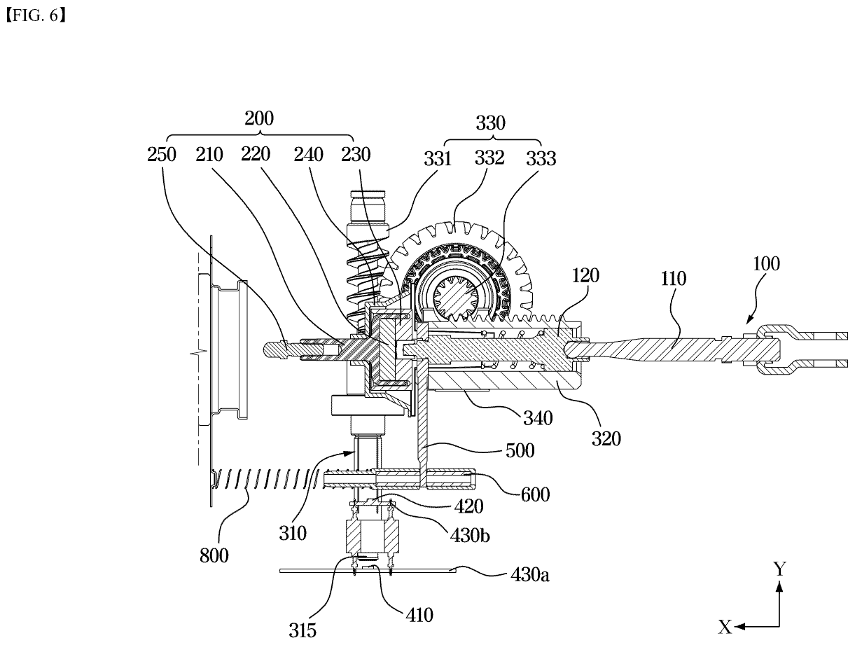

Hereinafter, an operation of the electronic brake apparatus 1 according to the disclosure will be described with reference to FIGS. 6 to 10.

FIGS. 6 to 9 are operation diagrams schematically showing operations of an electronic brake apparatus according to an embodiment of the disclosure.

FIG. 6 shows a state when no pedal effort is applied to the brake pedal of the electronic brake apparatus 1.

When no pedal effort is applied to the pedal, the input unit 100, the rack 320, and the output unit 200 may be positioned not to press the piston 21 of the master cylinder 20.

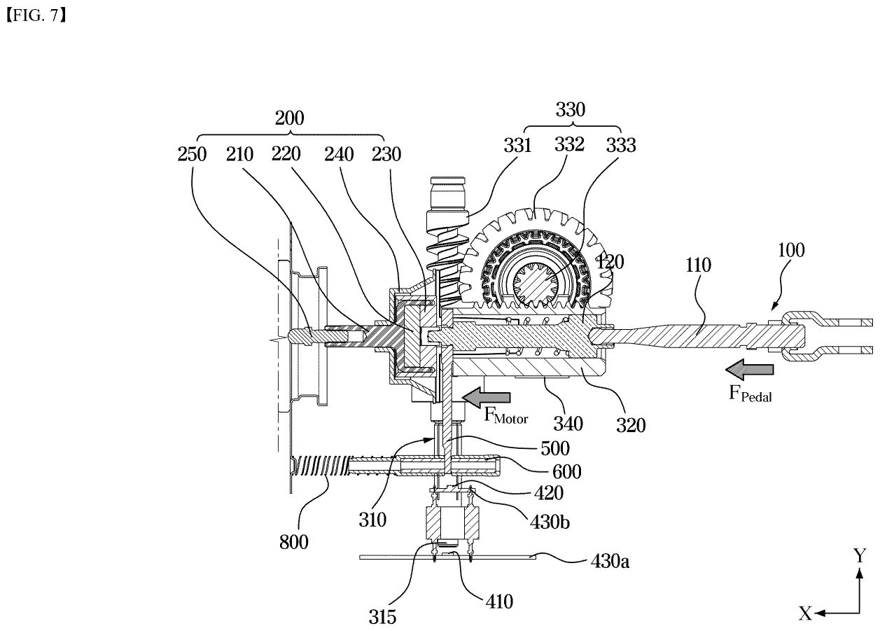

FIG. 7 shows a state in which the input unit 100 and the rack 320 press the output unit 200 when a pedal effort is applied to the brake pedal of the electronic brake apparatus 1.

When a driver applies a pedal effort to the brake pedal, the input unit 100 may move forward and the PTS magnet 600 connected through the sensor rod 500 may also move forward. The forward movement of the PTS magnet 600 may be detected by the pedal travel sensor 420, and the electronic control unit 400 may drive the motor 310 to move the rack 320 forward. As such, because the rack 320 moves forward by driving of the motor 310 and the rack 320 presses the output unit 200, the output unit 200 may be strongly pressed with a small force applied to the brake pedal by the driver to press the input unit 100, thereby increasing hydraulic pressure generated in the master cylinder 20. At this time, the control plunger 120 of the input unit 100 may come into contact with the reaction disk 220 of the output unit 200 and the driver may receive pedal feeling through the brake pedal.

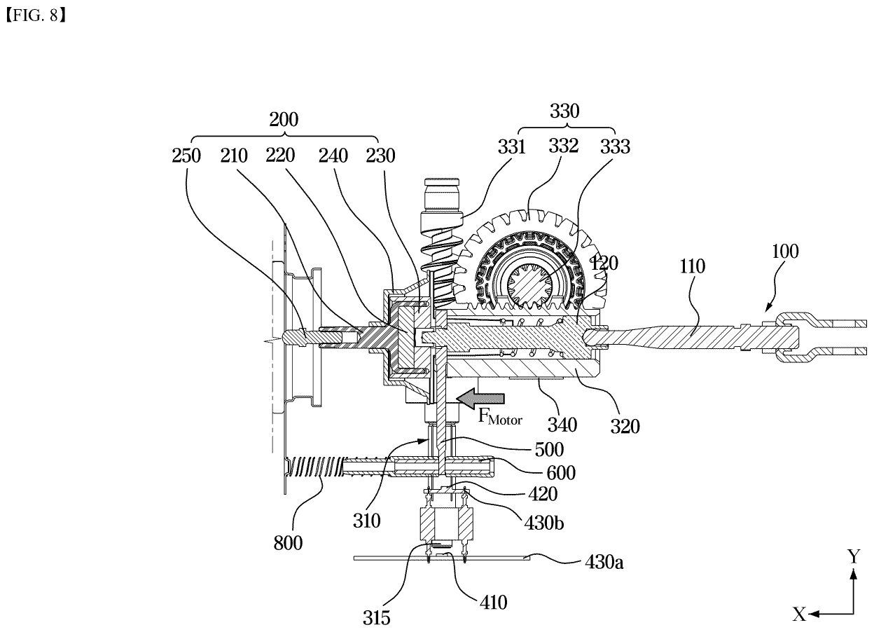

FIG. 8 shows a state in which the rack 320 presses the output unit 200 according to Adaptive Cruise Control (ACC) braking by the electronic control unit 400 of the electronic brake apparatus 1.

The electronic brake apparatus 1 according to the disclosure may perform braking according to determination by the electronic control unit 400 even when a driver applies no pedal effort to the brake pedal. During control such as ACC to maintain a constant speed of the vehicle, braking may be, when the speed of the vehicle exceeds preset speed, performed to reduce the speed of the vehicle. At this time, the electronic control unit 400 may drive the motor 310 to move the rack 320 forward. The rack 320 moved forward by the driving of the motor 310 may press the output unit 200, thereby performing braking without a pedal effort applied by the driver.

Meanwhile, when the rack 320 moves in the first direction to press a boost body 230 of the output unit 200, the rack 320 may come into contact with the input unit 100 and move the input unit 100 in the first direction.

For example, as shown in FIG. 8, the sensor rod 500 may be connected to the control plunger 120 of the input unit 100 between the output unit 200 and the rack 320. When the rack 320 moves forward by driving of the motor 310, the rack 320 may press the boost body 230 in the first direction, and simultaneously, one end of the rack 320 may come into contact with the sensor rod 500 to move the control plunger 120 connected to the sensor rod 500 forward in the first direction. Accordingly, the push rod 110 and the brake pedal connected to the push rod may also move forward together in the first direction by the forward movement of the control plunger 120. In the case in which the brake pedal remains without moving forward together while the rack 320 is driven by the motor 310 without a pedal stroke by a driver, no reaction force may be applied to the pedal upon a sudden pedal stroke by the driver, which may result in sudden braking. Accordingly, to prevent this, it may be preferable that, while the rack 320 moves forward, the input unit 100 also moves forward together.

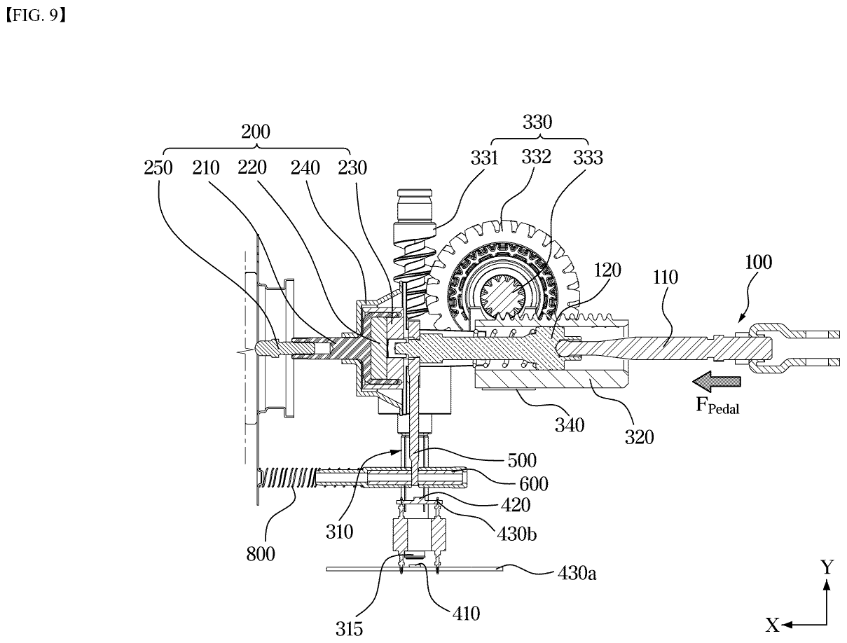

FIG. 9 shows a fallback driving state of the electronic brake apparatus 1.

In the electronic brake apparatus 1 according to an embodiment of the disclosure, the rack 320 may not operate due to various causes. The rack 320 may not operate when the electronic control unit 400 malfunctions, when the motor 310 does not operate, when no power is transmitted through the motion conversion unit 330, or when the rack 320 itself malfunctions. Even while the rack 320 does not operate, the driver should be able to perform braking through the brake pedal when he/she needs to brake the vehicle.

In the disclosure, while the rack 320 does not operate, the input unit 100 may directly press the output unit 200 to press the piston 21 of the master cylinder 20, as shown in FIG. 9. Thereby, the master cylinder 20 may generate hydraulic pressure to drive the wheel brake, thereby performing braking.

At this time, when the brake pedal is pressed to move in the first direction, the input unit 100 may move independently from the rack 320. Because the input unit 100 is movable independently from the rack 320 even while the rack 320 does not operate, the input unit 100 may directly press the output unit 200, thereby performing braking.

As described above, the sensor rod 500 may be connected to the control plunger 120 of the input unit 100 between the output unit 200 and the rack 320. Accordingly, when the rack 320 moves forward in the first direction, one end of the rack 320 may come into contact with the sensor rod 500 to move the control plunger 120 connected to the sensor rod 500 forward in the first direction, whereas, when the control plunger 120 moves forward in the first direction, the sensor rod 500 spaced from the one end of the rack 320 may move forward independently.

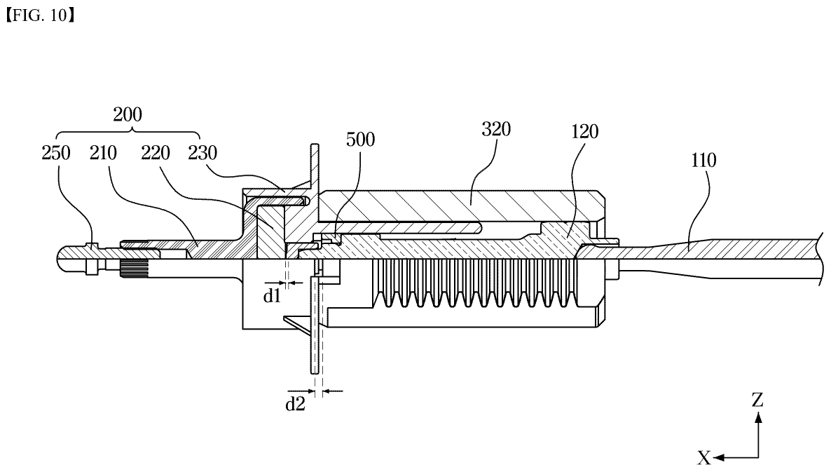

FIG. 10 is a partially cross-sectional view schematically showing a coupled state of an input unit, an output unit, and a rack of an electronic brake apparatus according to an embodiment of the disclosure.

As shown in FIG. 10, the reaction disk 110 may be provided in the output unit 200. The reaction disk 220 may be pressed by the control plunger 120 of the input unit 100 and the boost body 230, and when the reaction disk 220 is pressed by the control plunger 120 or the boost body 230, the reaction disk 220 may function to transfer a pressing force to the output rod 210.

While the brake pedal is not pressed, the control plunger 120 of the input unit 100 may be spaced a preset gap d1 (Lap gap) from the reaction disk 220. As such, because the gap d1 is provided between the control plunger 120 and the reaction disk 220, Jump in in which, at an initial stage at which the pedal is pressed, no output is generated even though a pedal effort is applied and when the control plunger 120 comes into contact with the reaction disk 220, an output increases instantaneously may occur.

Meanwhile, while the brake pedal is not pressed, the control plunger 120 of the input unit 100 and/or the sensor rod 500 may be spaced a preset gap d2 (Boost gap) from the boost body 230. During a normal operation, because, when the control plunger 120 moves forward in the first direction, the rack 320 moves forward by driving of the motor 310 to press the boost body 230 and move the boost body 230 forward and the boost body 230 presses the reaction disk 220, the control plunger 230 and/or the sensor rod 500 may be spaced from the boost body 230. However, when the rack 320 continues to move forward and reaches a driving limit, the rack 320 may no longer move forward. At this time, when a driver continues to press the brake pedal, the input unit 100 may further move forward and the control plunger 120 and/or the sensor rod 500 may directly come into contact with the boost body 230 and press the boost body 230. As such, when the input unit 100 directly presses the boost body 230, a driving force by the rack 320 may be no longer added. Accordingly, an output of the output unit 200 amplified through the booster 10 until the rack 320 reaches the driving limit may become equal to a magnitude of a pedal effort applied to the input device 100, and Knee-point may appear in a graph showing relationship between a pedal effort of the input unit 100 and an output of the output unit 200.

Meanwhile, even in fallback driving, because the rack 320 does not move forward, the input unit 100 may directly press the boost body 230 and the boost body 230 may press the reaction disk 220 to move the output rod 210 forward.

Through the above-described structure, the electronic brake apparatus according to an embodiment of the disclosure may reduce a package size and simplify a connection structure for sensors by positioning an integrated structure of the motor position sensor and the pedal travel sensor to one side of the electric booster on the PCB that configures the electronic circuit for control.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments are merely for illustrative purposes and not for limitation purposes.

1. An electronic brake apparatus comprising:
an input unit configured to move in a first direction according to a movement of a brake pedal;
an output unit configured to be pressed according to a movement of the input unit and press a piston of a master cylinder connected to the output unit in the first direction;
an electric booster including a motor, a rack configured to press the output unit, and a motion conversion unit configured to convert a rotational motion of the motor into a linear motion of the rack and move the rack forward or backward in the first direction; and
an electronic control unit configured to control an operation of the motor according to a movement of the input unit,
wherein the electronic control unit is positioned to one side in second direction of the electric booster.

2. The electronic brake apparatus of claim 1, wherein
the electronic control unit comprises:
a motor position sensor configured to detect a rotation of the motor;
a pedal travel sensor configured to detect a movement of the input unit; and
a Printed Circuit Board (PCB) configuring an electronic circuit for controlling the motor.

3. The electronic brake apparatus of claim 2, wherein
a rotation shaft of the motor is aligned in a second direction,
the PCB is positioned to one side in second direction of the motor, and
the motor position sensor is positioned to one side in second direction of the motor on the PCB and configured to detect a rotation of the motor.

4. The electronic brake apparatus of claim 2, further comprising:
a sensor rod connected to the input unit, extending in the second direction, and moving together with the input unit; and
a PTS magnet provided at one end of the sensor rod,
wherein the pedal travel sensor is provided to one side in second direction of the PTS magnet on the PCB and configured to detect a movement of the PTS magnet.

5. The electronic brake apparatus of claim 4, wherein
the rack includes a hollow portion formed in the first direction,
the input unit is positioned inside the hollow portion of the rack and moves in the first direction, and
the sensor rod is connected to the input unit between the output unit and the rack.

6. The electronic brake apparatus of claim 4, wherein
the PCB includes a first PCB and a second PCB,
the motor position sensor is positioned on the first PCB,
the pedal travel sensor is positioned on the second PCB, and
the first PCB is electrically connected to the second PCB.

7. The electronic brake apparatus of claim 1, wherein
the output unit includes:
an output rod configured to press the piston of the master cylinder;
a reaction disk configured to be pressed by the input unit and press the output rod; and
a boost body configured to be pressed by the rack or the input unit and press the reaction disk.

8. The electronic brake apparatus of claim 7, wherein,
when the rack moves forward in the first direction to press the boost body, the rack comes into contact with the input unit and moves the input unit forward in the first direction.

9. The electronic brake apparatus of claim 8, wherein,
when the brake pedal is pressed to move in the first direction, the input unit moves independently from the rack.

10. The electronic brake apparatus of claim 7, wherein,
while the brake pedal is not pressed, the input unit is spaced a preset gap from the reaction disk.
